(19) United States
(12) Patent Application Publication
(10) Pub. No.: US 2010/0044349 A1
(43) Pub. Date: Feb. 25, 2010

(54) METHOD OF WELDING ALUMINUM SHEETS

(75) Inventor: Ji Hong Yoo, Suwon-Si (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/388,604

(22) Filed: Feb. 19, 2009

(30) Foreign Application Priority Data
Aug. 22, 2008 (KR) 10-2008-0082275

(51) Int. Cl. B23K 11/00

(52) U.S. Cl. 219/118

(57) ABSTRACT

Disclosed herein is a method of welding aluminum sheets, including: supplying aluminum sheets overlapping each other between an upper electrode and a lower electrode; supplying thin metal sheets plated on both sides thereof with nickel (Ni) between the upper electrode and an upper aluminum sheet and between the lower electrode and a lower aluminum sheet, respectively; and supplying power to the upper and lower electrodes and then welding the aluminum sheets.

### CROSS-REFERENCE TO RELATED APPLICATIONS

This application claims under 35 U.S.C. §119(a) priority to Korean Application No. 10-2008-0082275, filed on Aug. 22, 2008, the disclosure of which is incorporated herein by reference in its entirety.

### BACKGROUND OF THE INVENTION

1. Field of the Invention

The present invention relates to a method of welding aluminum sheets in which welding electrodes are hardly contaminated and by which excellent welding quality can be obtained.

2. Background Art

Generally, a vehicle body or an outer panel of a vehicle is made of steel. Recently, in order to decrease the weight of a vehicle body, aluminum materials have been developed for this use, and, accordingly, technologies for assembling and joining the aluminum materials are also increasingly required.

Technologies for joining steel sheets have been developed, however, the development of technologies for joining aluminum sheets has progressed more slowly. Since an aluminum sheet has high electric conductivity, heat is rapidly dissipated through the sheet during welding, which makes it difficult to obtain enough heat to join the aluminum sheets. Further, since welding electrodes are easily contaminated, it is difficult to join the aluminum sheets using conventional spot welding methods.

Accordingly, a method of easily welding aluminum sheets by oxidizing the surfaces of the aluminum sheets to increase the surface resistance values thereof was proposed. However, when using this method, the contact resistance values between welding electrodes and aluminum sheets are not constant, and aluminum is melted and then adhered onto the surfaces of the welding electrodes due to the diffusion of aluminum and the formation of intermetallic compounds at high temperature, thus increasing the fractional occurrence of welding defects and decreasing the life span of the welding electrodes.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the present invention provides a method of welding aluminum sheets in which welding electrodes are hardly contaminated and by which excellent welding quality can be obtained.

Accordingly, in another aspect the present invention preferably provides a method of welding aluminum sheets, including: supplying aluminum sheets overlapped each other between an upper electrode and a lower electrode; supplying thin metal sheets plated on both sides thereof with nickel (Ni) between the upper electrode and an upper aluminum sheet and between the lower electrode and a lower aluminum sheet, respectively; and welding the aluminum sheets as supplying power to the upper and lower electrodes.

In preferred embodiments of the method, each of the thin metal sheets may include a steel sheet, and tin plated layers and nickel (Ni) plated layers sequentially formed on both sides of the steel sheet. In further embodiments, the steel sheet may preferably have a thickness of 100˜120 μm, each of the tin plated layers may preferably have a thickness of 0.1˜0.2 μm, and each of the nickel plated layers may preferably have a thickness of 0.8˜1.2 μm.

Further, in preferred embodiments of the method described herein, the thin metal sheets may be continuously supplied such that portions where the thin metal sheets are brought into contact with the electrodes are preferably changed each time welding is performed.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view for explaining a process of welding aluminum sheets according to an embodiment of the present invention;

FIG. 2 is a graph showing a temperature profile depending on the distance spaced apart from the welding area shown in FIG. 1.

FIG. 3 is a sectional view showing the thin metal sheet shown in FIG. 1;

FIG. 4 is a view showing a system for performing the process of welding aluminum sheets according to the present invention; and

FIG. 5 is a view showing an example of a process of welding aluminum sheets according to the present invention.

### DESCRIPTION OF THE PREFERRED EMBODIMENTS

As described herein, the present invention includes a method of welding aluminum sheets, comprising supplying aluminum sheets, supplying thin metal sheets plated on both sides thereof with nickel (Ni), and welding the aluminum sheets.

In one embodiment, the aluminum sheets overlap each other between an upper electrode and a lower electrode.

In another embodiment, the thin metal sheets plated on both sides thereof with nickel (Ni) are supplied between the upper electrode and an upper aluminum sheet and between the lower electrode and a lower aluminum sheet, respectively.

In another related embodiment, the method comprises supplying power to the upper and lower electrodes.

In still another embodiment, each of the thin metal sheets comprises a steel sheet, a tin plated layer and a nickel (Ni) plated layer.

In another further embodiment, the tin plated layers and nickel (Ni) plated layers are sequentially formed on both sides of the steel sheet.

In another aspect, the invention features a motor vehicle comprising aluminum sheets manufactured by the method of welding as described herein.

Hereinafter, preferred embodiments of the present invention will be described in detail with reference to the attached drawings.

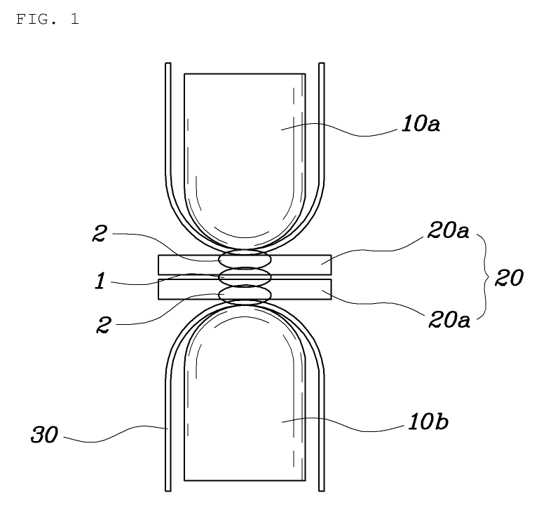

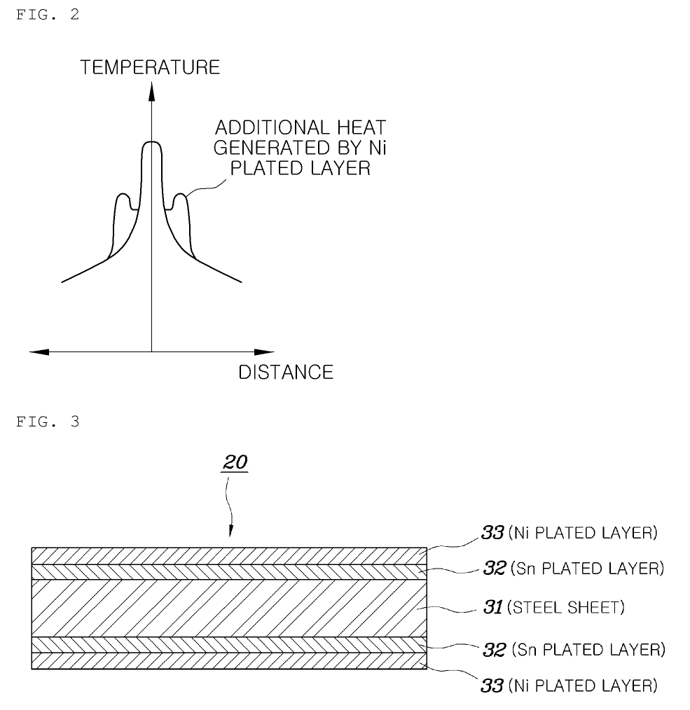

According to certain preferred embodiments of the invention, and referring to FIGS. 1 and 2, two aluminum sheets 20 overlapping each other are preferably supplied between an upper electrode 10a and a lower electrode 10b suitably spaced apart from each other. In certain preferred embodiments, these upper and lower electrodes 10a and 10b are copper electrodes. Preferably, thin metal sheets 30 preferably plated on both sides thereof with nickel (Ni) are suitably interposed between the upper electrode 10a and an upper aluminum sheet 20a and between the lower electrode 10b and a lower aluminum sheet 20b, respectively. Preferably, when power is supplied to the upper and lower electrodes 10a and 10b in a state in which the upper and lower electrodes 10a and 10b are brought into contact with the upper and lower aluminum sheets 20a and 20b through the thin metal sheets 30, additional resistance is generated between the thin metal sheets 30 and the aluminum sheets 20, except at the welding area 1 (see FIG. 2), and thus a process of suitably welding the aluminum sheets 20 can be easily performed.

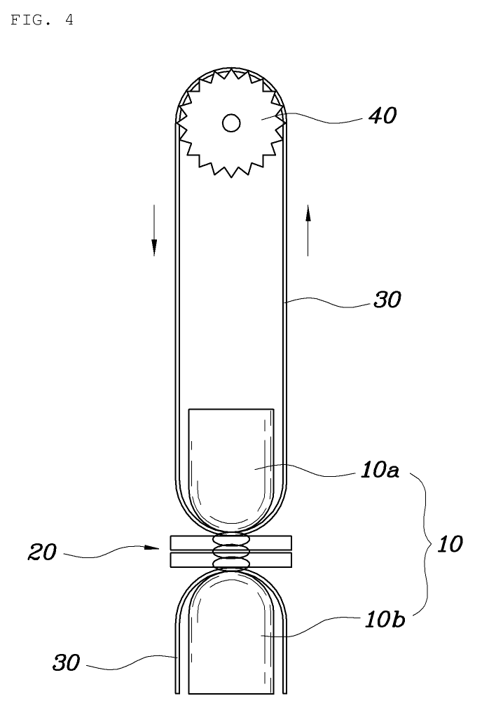

According to further preferred embodiments of the invention, and referring to FIG. 3, each of the thin metal sheets 30 has a preferred structure in which tin (Sn) plated layers 32 and nickel (Ni) plated layers 33 are suitably sequentially formed on both sides of a steel sheet 31. Preferably, the steel sheet 31 serves to add resistance necessary for welding the aluminum sheets 20, and the tin plated layers 32 serve to suitably improve current efficiency because they have excellent wettability and adhesivity. In further embodiments, the nickel plated layers 33 serve to improve smoothness and thus increase current density, and serve to prevent intermetallic compounds from being formed between the steel sheet 31 and electrodes 10 and thus suitably increase the life span of the electrodes 10.

In other certain embodiments, it is preferred that the thickness of the steel sheet 31 be in the range of from 100 to 120 μm. Preferably, when the thickness of the steel sheet 31 is less than 100 μm, it is considerably difficult to produce a steel sheet having a thickness of less than 100 μm, and when the thickness thereof is more than 120 μm, the cooling function of the cooling water flowing in the electrodes 10 is suitably deteriorated, and thus the steel sheet 31 is melted and then suitably adhered on the aluminum sheets 20. Preferably, when the tin plated layers 32 are not formed on both sides of the steel sheet 31, the adhesion between the steel sheet 31 and the nickel plated layers 33 is suitably decreased, and thus current efficiency is decreased, so that it is preferred that the thickness of each of the tin plated layers 32 be in the range of from 0.1 to 0.2 μm. In further embodiments, it preferred that the thickness of each of the nickel plated layers 33 be in the range of from 0.8 to 1.2 μm. Preferably, when the thickness of each of the nickel plated layers 33 is less than 0.8 μm, current density cannot be efficiently increased, and thus a large amount of current is consumed, and when the thickness thereof is more than 1.2 μm, economic efficiency is low in comparison with gained plating effects.

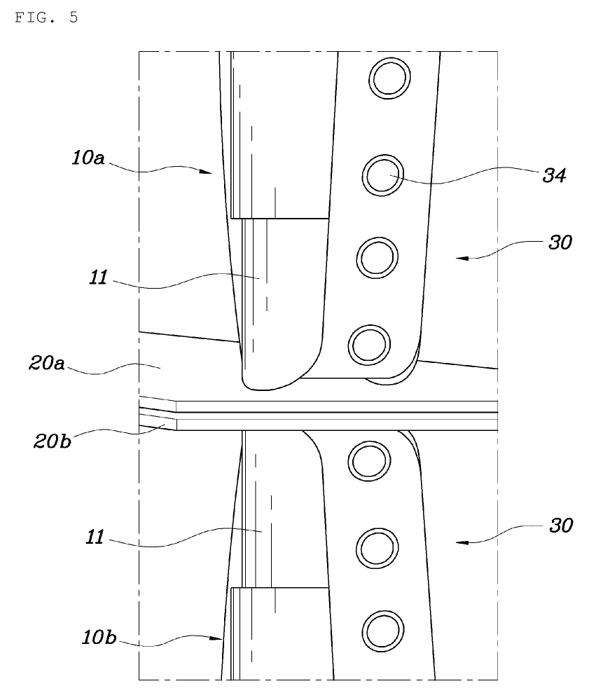

A process of supplying the thin metal sheets will be described according to certain preferred embodiments of the invention, with reference to exemplary FIGS. 4 and 5.

In certain preferred embodiments, and as shown in FIG. 4, the thin metal sheets 30 are continuously supplied between the electrodes 10 and the aluminum sheets 20 by a supply unit 40. Preferably, the supply unit 40 rotates the thin metal sheets 30 and moves them to next spot-weld before next welding after first welding. Accordingly, since the thin metal sheets 30 are continuously supplied by the supply unit 40, the resistance values between the electrodes 10 and the thin metal sheets 30 are preferably maintained constant, and thus uniform and excellent weld quality can be obtained. According to certain preferred embodiments, for example as shown in FIG. 4, the supply unit 40 is preferably fabricated in the form of a sprocket, but may be fabricated in various forms using conventional technologies. Further, according to other exemplary embodiments, it is not important whether the thin metal sheets are supplied before or after the aluminum sheets to be welded are supplied.

According to other preferred embodiments of the invention, and as shown in FIG. 5, FIG. 5 is an experimental example of a preferred process of continuously welding aluminum sheets several times. From FIG. 5, it can be seen that, after the welding, spot-welds are formed on the thin metal sheets 30 at regular intervals. As described herein as as a result of the experiments, in conventional spot welding, welding electrodes must be dressed after 100˜200 spot-welds are formed, but, preferably in certain embodiments of the present invention, the dressing period of the electrodes can be suitably increased 10 or more times. According to further exemplary embodiments, it was found that all weld-spots exhibit uniform and excellent welding quality. In certain embodiments, the non-described reference numeral “11” is a welding guide.

As described herein, the method of welding aluminum sheets according to the present invention provides that the direct contact between aluminum sheets and electrodes is prevented by thin metal sheets, and that additional resistance is generated between aluminum sheets and thin metal sheets, so that the contamination of welding electrodes can be suitably prevented, and the strength and welding quality of spot-welds can be improved.

Further, as described in the preferred aspects and embodiments herein, in the method of welding aluminum sheets according to the present invention thin metal sheets are continuously supplied, and thus workability can be improved.

As described above, although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of welding aluminum sheets, comprising:
supplying aluminum sheets, wherein the sheets overlap each other between an upper electrode and a lower electrode;
supplying thin metal sheets plated on both sides thereof with nickel (Ni) between the upper electrode and an upper aluminum sheet and between the lower electrode and a lower aluminum sheet, respectively; and
welding the aluminum sheets as supplying power to the upper and lower electrodes.

2. The method of welding aluminum sheets according to claim 1, wherein each of the thin metal sheets comprises: a steel sheet, and tin plated layers and nickel (Ni) plated layers sequentially formed on both sides of the steel sheet.

3. The method of welding aluminum sheets according to claim 2, wherein the steel sheet has a thickness of 100˜120 μm, each of the tin plated layers has a thickness of 0.1˜0.2 μm, and each of the nickel plated layers has a thickness of 0.8˜1.2 μm.

4. The method of welding aluminum sheets according to claim 1, wherein the thin metal sheets are continuously supplied such that portions where the thin metal sheets are brought into contact with the electrodes are changed each time welding is performed.

5. A method of welding aluminum sheets, comprising:
supplying aluminum sheets;
supplying thin metal sheets plated on both sides thereof with nickel (Ni); and
welding the aluminum sheets.

6. The method of welding aluminum sheets of claim 5, wherein the aluminum sheets overlap each other between an upper electrode and a lower electrode.

7. The method of welding aluminum sheets of claim 5, wherein the thin metal sheets plated on both sides thereof with nickel (Ni) are supplied between the upper electrode and an upper aluminum sheet and between the lower electrode and a lower aluminum sheet, respectively.

8. The method of welding aluminum sheets of claim 5, further comprising the step of supplying power to the upper and lower electrodes.

9. The method of welding aluminum sheets according to claim 5, wherein each of the thin metal sheets comprises: a steel sheet, a tin plated layer and a nickel (Ni) plated layer.

10. The method of welding aluminum sheets according to claim 9, wherein the tin plated layers and nickel (Ni) plated layers are sequentially formed on both sides of the steel sheet.

11. A motor vehicle comprising aluminum sheets manufactured by the method of welding of claim 1.

12. A motor vehicle comprising aluminum sheets manufactured by the method of welding of claim 9.
